(19) United States
(12) Patent Application Publication
(10) Pub. No.: US 2012/0089945 A1
(43) Pub. Date: Apr. 12, 2012

(54) EFFICIENT NAVIGATION BASED ON IMPORTANCE WITH AUDIO OUTPUT OPTION

(75) Inventors: Rachel K.E. Bellamy, Bedford, NY (US); Jonathan P. Brezin, New York, NY (US); John T. Richards, Chappaqua, NY (US); Calvin B. Swart, Poughkeepsie, NY (US); John C. Thomas, JR., Yorktown Height, NY (US); Sharon M. Trewin, Croton-On-Hudson, NY (US)

(73) Assignee: INTERNATIONAL BUSINESS MACHINES CORPORATION, Armonk, NY (US)

(21) Appl. No.: 12/902,782

(22) Filed: Oct. 12, 2010

(51) Int. Cl. G06F 3/048; G06F 17/30

(52) U.S. Cl. 715/817; 707/713; 707/E17.131

(57) ABSTRACT

A system and method for navigating items includes computing an importance of a plurality of items. The importance is compared to one of a threshold or other items. Upon encountering a next item, a determination to skip the item or stop on the item is made based upon a comparison of the importance.

### BACKGROUND

1. Technical Field

The present invention relates to efficient navigation of items, and more particularly to systems and method for navigating items based upon importance.

2. Description of the Related Art

When searching audio information, whether an audio book or a web page, users typically have the option of stepping through the information item by item. While effective, this process is very slow. Jumping a fixed number of items forward or backward may be faster but can miss important items. Keyword searching causes the user to lose the context in which the item appears.

To navigate, using structure in the information such as headings, the user may need to build and maintain a hierarchical mental model of the information structure, which is difficult to do. This strategy also relies on provisioning of meaningful structure by the author (e.g., that things were cataloged or laid out logically), which is often not the case in Web pages. The user must then decide what structural item to use for navigation, and switch between navigation modes accordingly.

### SUMMARY

A system and method for navigating items includes computing an importance of a plurality of items. The importance is compared to one of a threshold or other items. Upon encountering a next item, a determination to skip the item or stop on the item is made based upon a comparison of the importance and/or the number of consecutive skipped items.

A system and method for navigating items includes dividing content into a plurality of items; computing an importance value of the plurality of items by at least one of: inferring an importance based upon a structural role of the item, settings of a user device, actions of others; setting an importance based upon user defined criteria, and setting an importance based upon user characteristics; comparing the importance value to a threshold; and skipping items in the plurality of items until an item that includes an importance score which equals or exceeds the threshold is encountered.

A system for navigating items includes a processor and a memory coupled to the processor. The memory includes an importance module stored in the memory and configured to compute importance values for a plurality of items, and a navigation tool stored in the memory and configured to: compare the importance values to a threshold; and determine whether to skip a next item or stop on the next item based upon a comparison of the importance value of the next item to the threshold.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for navigating items using importance in accordance with one embodiment;

FIG. 2 is a block/flow diagram showing a system for navigating items using importance and enabling acoustic output to permit eyes busy navigation in accordance with one embodiment; and

FIG. 3 is a block/flow diagram showing another system/method for navigating items using importance and enabling acoustic output to permit eyes busy navigation in accordance with another embodiment.

### DETAILED DESCRIPTION OF PREFERRED EMBODIMENTS

In accordance with the present principles, navigation systems, methods and commands are provided which permit a simple linear organizational approach to searchable content, and provides a way to accelerate navigation while maintaining a sense of context and reducing the chance of important information being missed. The present approach leverages information foraging theory, which proposes that humans search for information using built-in foraging mechanisms that evolved in animal life to support the search for food. An ‘information scent’ of an item refers to the user's estimation of how similar the item is to their information goal. Users will follow high scent and turn away from low scent areas.

In one embodiment, an audio navigation system/method of structured information, such as a Web page or audio book is provided. The system/method implements a ‘scent-based jump’ navigation command (‘jump’). With this system/method, items in a source are assigned an information value, and the ‘jump’ command brings the user to a next item whose information value exceeds a threshold. Information values are assigned using a combination of structural cues, metadata and information scent. The jump command combines the best qualities of existing navigation commands—it is efficient, has low risk of missing important items, provides a sense of context, and does not require the user to anticipate the structure of the content and switch between different navigation modes. The present embodiments may be useful for anyone operating in an ‘eyes-busy’ situation, blind individuals navigating Web pages by audio, and mobile individuals with low-end devices, among other applications.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage de-vice, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

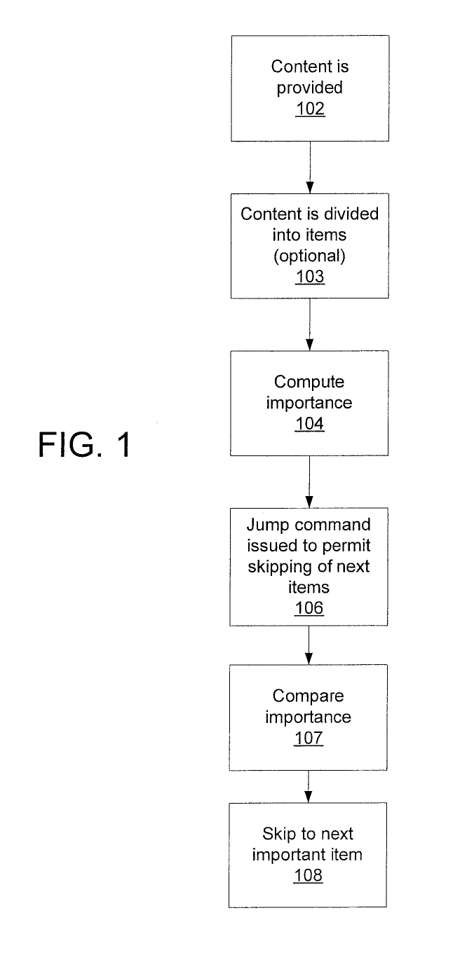

Referring now to the drawings in which like numerals represent the same or similar elements and initially to FIG. 1, a block/flow diagram describes a system/method for navigating using an importance scent in accordance with the present principles. In block 102, content to be navigated is provided. This may include network navigation, records, files or data navigation, or any other list of items that have searchable attributes. In block 103, one example includes a page or document. The page is divided into items, such as text paragraphs, links, headings, and lists.

In block 104, for each item, an importance value is computed. An importance value may be computed in a plurality of ways. In one example, an importance formula or routine computes importance based upon user customizable criteria. The user customizable criteria may include a number of occurrences of a noun, word, phrase, name, etc., may be weighted on the types of items, e.g., links have a higher weight than regular text, etc. The importance may be based upon a structural role of the item, e.g., a heading, section titles, etc. The importance may consider prior item browsing history, etc.

In block 106, a ‘jump’ command is provided to enable a user to step through the items to find a next potentially important item. The ‘jump’ command operates as follows. When the ‘jump’ command is issued, the method searches forward (or backward) from a current position until finding an item whose importance value exceeds a threshold, or until a maximum step threshold is reached. The thresholds are preferably user determined (or may be a default or based on current conditions). The importance score for each item is compared against this threshold or other items in block 107. The ‘jump’ command may be a setting that is selected by a user to provide a navigation option. It should be understood that the command may be modified or customized as desired. For example, the ‘jump’ command may be activated by a virtual button or the like and permit the user to perform navigation in accordance with the present principles until the jump navigation mode is deactivated.

In block 108, the command jumps to the next important item. An important item is defined as one that carries, or is likely to carry, good information scent. Headers, items that are visually highlighted, list items in main or supporting content, items that contain terms related to the link the user followed to get here, or to recent searches by the user, may have high importance values. Items that are repeated from the previously visited page (navigation) may have a lower importance value. When the user's search goal is known, items with strong similarity to the goal (high information scent) have a high importance value.

Potential applications of this invention include any situation in which a user needs to access information while their hands and eyes are busy. For example, a medical practitioner accessing medical records or drug information, an undersea diver repairing an oil rig, an airplane pilot checking a procedure manual, a driver using an audio book, or an individual constructing a piece of furniture at home. Applications also include access to books and Web-based information and applications by people who are blind, and people using cell phones with little or no display capability, as is common in emerging economies.

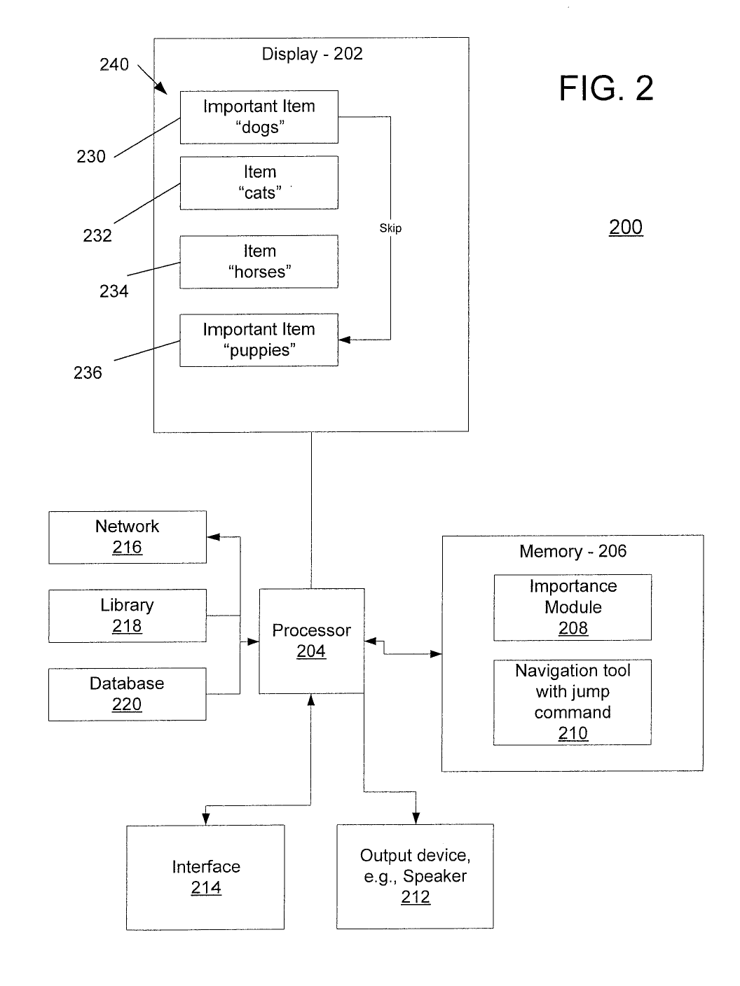

Referring to FIG. 2, a system 200 is illustratively shown which is configured to provide a navigation system in accordance with the present principles. System 200 may include a workstation, computer, portable computer, cell phone, personal digital assistant or any other computing device having navigation tools or systems. The system 200 may be implemented as a service by a service provided through one or more networks or the like. In one example, a person may have a very basic phone, which sends dialed digits and audio to a remote server where information to be navigated is hosted and navigation tools in accordance with the present principles are running. The server navigates the document and sends audio content to the phone in response to the user's commands (which could be speech or button presses).

System 200 includes one or more processors 204 capable of executing software stored in memory 206. Processor 204 interacts with a user interface 214 and one or more speakers 212 or other output devices. A display 202 may be included may be coupled to the processor 204 to display items (e.g., items 230, 232, 234 and 236). Items will be collectively referred to by reference number 240.

Items 240 may include search results from a search conducted with a browser on a network 216, or search results from a search conducted of a library 218 (e.g., a music library, medical records, etc. or a database 220. A source of content should not be construed as limited to those illustrated in FIG. 2. The source of content may include any content including a single document, features on a web page, etc.

Memory 206 includes an importance module 208, which is configured to determine an importance values or score of each item or entry in source content, e.g., in a search result, in a document, etc. Memory 206 also include a navigation tool 210 configured to navigate through the items 240 in accordance with the importance score generated by the importance module 208.

The importance module 208 may compute the importance values in many different ways. For example, in one embodiment, latent semantic analysis is employed to compute importance based on scent keywords provided by the user. In one instance, the user may choose items 240 having a reference to “animals” as being important, “domesticated animals” as being very important and “dogs” as being the most important.

Importance may be inferred based on a user's recent actions, e.g., previous searches, software applications used, recent emails, names in a contact list, contents on a user's desktop, search topics, etc. Importance may be inferred from the actions of others on the same source material, e.g., a particular item may have been viewed or ordered by more people than other items. Importance values may also be weighted, e.g., according to the previous actions of the user or others on the same material. Weighting may be user customized, e.g., in the “animals” example above.

The importance module 208 may use cues from visual formatting, such as font size and weight to estimate importance of an item. In music applications, the popularity of a song or band may be employed to influence an item's importance. The importance of a heading may be supplemented by the importance of the sections within that heading, or the scent of the first few words in the section.

The importance module 208 may adapt its computation according to a type of item. For example, a heading in a text document may be considered important if it has a moderate similarity to a goal, while a paragraph may not be important unless the similarity level is high. The importance module 208 may provide an ability to incrementally add terms of information to a set of scent keywords as navigation progresses, to narrow down the search or reduce the number of items 240. More sophisticated importance computations are also contemplated. For example, importance may be based on a likelihood that an item will carry scent in general, with no knowledge of the user's information goal. For example, if a user is a football fan, general topics or items related to football will become important or more important.

For illustrative purposes, a user has input search terms at the interface 214 and conducts a search of the network 216 (e.g., the Internet). For this example, a user conducts a search that yields items 230, 232, 234 and 236. Since in this case, the user may have selected for the importance model 208 that “animals” are important, “domesticated animals” are very important and “dogs” as being the most important, a threshold was set so as to indicate only the most important items. In navigating the items 240, the navigation tool skips to item 230 since it includes “dogs”. In one embodiment, the system, may output “item 230 includes “dogs”. This may be rendered acoustically using speaker 212 or other output device. The user may wish to navigate to a next item. Using the interface 214, (which may include a microphone for speaking a command), the user says “jump” (or any other input, e.g., clicking a button, pressing a button, etc.). The navigation module 210 employs the ‘jump’ command to skip items 232 and 234, which are very important (“cats” and “horses” are domesticated animals), but do not meet the threshold of the most important. Item 236 is stopped on as this item includes “puppies”, which are semantically equivalent to dogs (most important) and meets the threshold.

The ‘jump’ command may give audio feedback indicating the number of items skipped, type of items skipped, and scent of items that were skipped. In this case, the feedback may include: “skipped five, including cats and horses” or “skipped one heading”, or a sequence of five tones indicating that five items were skipped, etc. The acoustic properties of such tones may be modified to provide information about the scent of the skipped items and/or their type (e.g. heading, list item, link). The command can continue to skip forward, reading each important item, until stopped by the user. In this case, the feedback may include: “dogs, puppies”. At any time, the user can say ‘jump’ or say a scent word (e.g., American breeds, etc.) to add to the existing set of keywords. The command could take the user to the next important item in the document's logical order, or to the next highest rated item in an importance ranking of items in the document. Other settings or controls are also contemplated. For example, a best item in the list may be found (e.g., the one with a highest importance score of all the listed items).

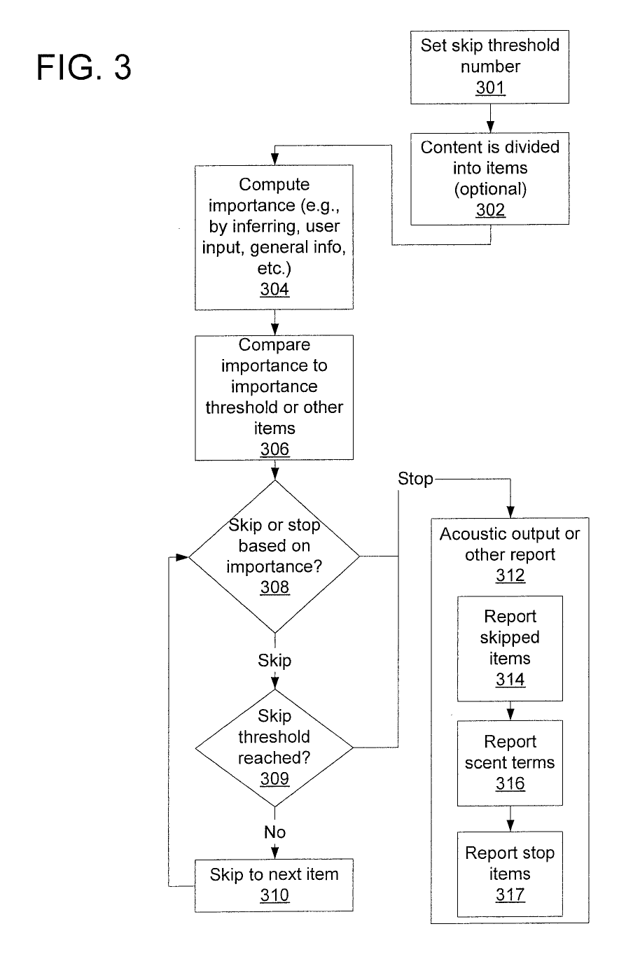

Referring to FIG. 3, a system/method for navigating items is illustratively depicted in accordance with another embodiment. In block 301, a maximum step or skip threshold may be set and only a number of items less than the maximum step threshold can be skipped with each jump. In block 302, content may be divided into a plurality of items. The content may include web pages, documents, navigation results, etc. In block 304, an importance or importance value/score of a plurality of items is computed. The importance may be computed by inferring an importance based upon attributes of the item, settings of a user device, actions of others, setting an importance based upon user defined criteria, setting an importance based upon user characteristics, etc. Importance is preferably based on items with a strong information scent using information foraging theory. Other ways of computing importance are also contemplated.

In block 306, the importance is compared to an importance threshold or may be compared to the importance values of other items in the plurality of items. For example, if looking for the top three important items the item importance will be compared between items to make this determination. In one embodiment, the listing of items may be reordered in accordance with importance. In block 308, a determination is made as to whether a next item is to be skipped or stopped on based upon a comparison of the importance value. This may include stopping on an item if the importance score is equal to or exceeds the importance threshold (or has the requisite importance value to meet a given criterion).

If the result in block 308 is to skip, a determination is made as to whether this skip would exceed the skip threshold in block 309. If the skip exceeds the skip threshold, a current item is stopped on and reporting occurs in block 312. If the skip does not exceed the threshold, a next item in the plurality of items is skipped to in block 310. The path returns to block 308 to determine whether the item skipped to meets the importance threshold (or is less important than other items in the plurality of items). Skipping continues until a stop is performed.

In block 312, output is provided. In a particularly useful embodiment, acoustical output is provided to enable eyes-busy or blind navigation. This may include that items that have been skipped are acoustically reported, e.g., using non-speech or speech-based audio in block 314 or scent terms of an item or items are acoustically reported, e.g., using non-speech or speech-based audio, in block 316. In block 317, items that are stopped on are also acoustically reported. e.g., using non-speech or speech-based audio. Navigation can continue as needed.

Having described preferred embodiments of a system and method for audio navigation command supporting efficient scanning (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for navigating items, comprising:
computing an importance of a plurality of items;
comparing the importance to one of a threshold or other items;
upon encountering a next item, determining whether to skip the item or stop on the item based upon a comparison of the importance value.

2. The method as recited in claim 1, wherein computing an importance includes inferring an importance based upon at least one of a structural role of the item, settings of a user device, and actions of others.

3. The method as recited in claim 1, wherein computing an importance includes setting an importance based upon user defined criteria.

4. The method as recited in claim 1, wherein computing an importance includes setting an importance based upon user characteristics.

5. The method as recited in claim 1, wherein computing an importance includes computing an importance value or score.

6. The method as recited in claim 5, wherein determining whether to skip the item or stop on the item based upon a comparison of the importance value includes stopping on an item if the importance score is equal to or exceeds the threshold.

7. The method as recited in claim 1, further comprising:
acoustically reporting that the item is skipped.

8. The method as recited in claim 1, farther comprising:
acoustically reporting scent terms of an item.

9. The method as recited in claim 1, wherein determining whether to skip the item or stop on the item includes executing a jump command configured to evaluate next items in the plurality of items to determine if the next items should be skipped and moving a current position within the plurality of items to a next item that meets the threshold or is more important than other items in the plurality of items.

10. The method as recited in claim 1, further comprising:
dividing a content source into the plurality of items.

11. The method as recited in claim 1, further comprising:
conducting a search such that the search results yield the plurality of items.

12. The method as recited in claim 1, further comprising:
setting a maximum step threshold and only skipping a number of items less than the maximum step threshold.

13. A computer readable storage medium comprising a computer readable program for navigating items, wherein the computer readable program when executed on a computer causes the computer to:
computing an importance of a plurality of items;
comparing the importance to one UI a threshold or other items;
upon encountering a next item, determining whether to skip the item or stop on the item based upon a comparison of the importance value.

14. A method for navigating items, comprising:
dividing content into a plurality of items;
computing an importance value of the plurality of items by at least one of: inferring an importance based upon a structural role of the item, settings of a user device, actions of others; setting an importance based upon user defined criteria, and setting an importance based upon user characteristics;
comparing the importance value to a threshold; and
skipping items in the plurality of items until an item that includes an importance score which equals or exceeds the threshold is encountered.

15. The method as recited in claim 14, further comprising:
acoustically reporting that an item is skipped.

16. The method as recited in claim 14, further comprising:
acoustically reporting scent terms of an item.

17. The method as recited in claim 14, wherein skipping includes:
executing a skip command configured to evaluate next items in the plurality of items to determine if the next items should be skipped; and
skipping the items that do not meet the threshold.

18. The method as recited in claim 14, wherein the threshold is determined by comparing importance values with other items in the plurality of items.

19. The method as recited in claim 14, further comprising:
dividing a content source into the plurality of items.

20. The method as recited in claim 14, further comprising:
conducting a search such that the search results yield the plurality of items.

21. The method as recited in claim 14, further comprising:
setting a maximum step threshold and only skipping a number of items less than the maximum step threshold.

22. A system for navigating items, comprising:
a processor;
a memory coupled to the processor, the memory including an importance module stored in the memory and configured to compute importance values for a plurality of items, and a navigation tool stored in the memory and configured to:
compare the importance values to a threshold; and
determine whether to skip a next item or stop on the next item based upon a comparison of the importance value of the next item to the threshold.

23. The system as recited in claim 22, wherein the importance value includes a least one of an inferred importance based upon attributes of the item, settings of a user device, actions of others; an importance based on user defined criteria; and an importance based upon user characteristics.

24. The system as recited in claim 22, further comprising:
a speaker coupled to the processors to acoustically report at least one of that an item is skipped, and scent terms of an item.

25. The system as recited in claim 22, wherein the navigation tool issues a skip command configured to evaluate next items in the plurality of items to determine if the next items should be skipped and to skip the items that do not meet the threshold or are less important than other items in the plurality of items.
